(19) United States
(12) Patent Application Publication
(10) Pub. No.: US 2016/0141811 A1
(43) Pub. Date: May 19, 2016

(54) ELECTRICAL CONNECTOR, MANUFACTURING METHOD THEREOF AND COMMUNICATION DEVICE

(71) Applicant: Delta Electronics (Chen Zhou) Co., Ltd., Chen Zhou City (CN)

(72) Inventors: Zhixiang HOU, Chen Zhou City (CN); Wangjun HE, Chen Zhou City (CN); Jung-jui WANG, Chen Zhou City (CN)

(21) Appl. No.: 14/797,176

(22) Filed: Jul. 12, 2015

(30) Foreign Application Priority Data
Nov. 19, 2014 (CN) 201410662977.X

(51) Int. Cl. H01R 13/66; H01R 12/70; H01R 13/717

(52) U.S. Cl. CPC H01R 13/6691; H01R 13/7175; H01R 12/7076

(57) ABSTRACT

The disclosure provides an electrical connector, its manufacturing method, and a communication device. The electrical connector includes an insulator, on which at least one docking socket is provided; a housing provided outside the insulator; a signal processing unit provided in the insulator; and a signal display unit comprising a signal display circuit board, at least one SMD (surface-mounted-device) LED electrically coupled to the signal display circuit board, and at least one connection terminal electrically coupled to an exterior circuit board or the signal processing unit.

### CROSS REFERENCE TO RELATED APPLICATIONS

This application claims the priority to and the benefit of the Chinese patent application No. 201410662977.X, filed on Nov. 19, 2014, and entitled “Electrical Connector, Manufacturing Method thereof and Communication Device”, which is incorporated herein by reference in its entirety.

### TECHNICAL FIELD

The disclosure relates generally to an electrical connector mainly for signal transmission of communication data, a method for manufacturing the electrical connector, and a communication device using the same. Particularly, the disclosure relates to an electrical connector provided with a signal display unit, a method for manufacturing the connector, and a communication device using the same.

### BACKGROUND

An electrical connector is generally used to connect electronic devices with the network or other related electronic devices.

A conventional electrical connector includes an insulator, a housing provided outside the insulator and a signal processing unit. The insulator is provided with a module socket for accommodating the signal processing unit and a docking socket for a user to connect with an interface, for example, a plug. The signal processing unit includes a base, a PCB unit provided in the base and an output terminal. In order to display connection state of the user's connection interface and the docking socket of the electrical connector, some electrical connectors are provided with a signal display unit.

As shown in FIG. 1A, a conventional LED 100 includes an illuminant 110 and pins 120 connected to the illuminant 110, wherein the pins 120 of the LED 100 are in a shape of straight line.

As shown in FIG. 1B, in the conventional electrical connector, the signal display unit is generally fabricated with the conventional LED 100. In order to install the signal display unit to a proper place of the electrical connector, it is conventional to bend the straight-line-shaped pins 120 of the LED 100 into a desired shape manually by a bending tool, and a bending LED 200 with bent pins 220 is achieved. The illuminant 210 of the bending LED 200 is identical to the illuminant 110 of the LED 100.

The conventional process for manufacturing the electrical connector includes the steps of: inserting the signal processing unit having a function of filtering wave into the module socket of the insulator; installing the above bending LED 200 onto the insulator; gluing the LED 200 to the insulator; and then placing the insulator on the tool of LED cutting pins manually so that the pins are cut into desired length; and finally, assembling a shell outside the insulator, and thereby the electrical connector is formed.

The conventional electrical connector has following deficiencies:

Firstly, the signal display unit is manually manufactured by means of special tools, which will inevitably make the process complicated, the operation difficult, and the effectiveness low.

Secondly, for the electrical connectors with different structure, the LED with different pins in shape has to be used, and the different bending tools are required to be equipped for the bending operation. The bending tool may be costly and difficult for automatic production.

Thirdly, the quality of the LED is not stable when the pins thereof are bent. For example, the pins tend to be broken out, and the LED is poorly contacted.

The foresaid information as disclosed in the background art only serves to enhance understanding of the background of the disclosure, thereby it may contains information not to constitute the prior art as known by those skilled in the art.

### SUMMARY

An aspect of the present disclosure may help overcome at least one deficiency of the prior art, and provide an electrical connector which may simplify the manufacture process.

Another aspect of the present disclosure may help provide a method for manufacturing the electrical connector.

Another aspect of the present disclosure may help provide a communication device including the present electrical connector.

Additional aspects and advantages of the disclosure will in part set forth in the description below, and in part will become obvious from the description, or may be learned from practice of the present disclosure.

According to one aspect of the present disclosure, an electrical connector includes an insulator, on which at least one docking socket is provided; a housing provided outside the insulator; a signal processing unit provided in the insulator; and at least one signal display unit comprising a signal display circuit board, at least one SMD (surface-mounted-device) LED electrically coupled to the signal display circuit board, and at least one connection terminal electrically coupled to an exterior circuit board or the signal processing unit.

According to another aspect of the present disclosure, an electrical connector includes an insulator, on which at least one docking socket is provided; a housing provided outside the insulator; a signal processing unit provided in the insulator and including a signal processing circuit board; and at least one signal display unit including an SMD LED electrically coupled to the signal processing circuit board.

According to another aspect of the present disclosure, a method for manufacturing the electrical connector includes the following steps:

providing an insulator, on which at least one docking socket is provided;

providing a signal processing unit;

providing at least one signal display unit, which comprises a signal display circuit board and at least one SMD LED electrically coupled to the signal display circuit board;

installing the at least one signal display unit and the signal processing unit on the insulator; and

installing a housing outside the insulator.

According to another aspect of the present disclosure, a communication device includes the electrical connector according to the present disclosure, or includes the electrical connector manufactured by the method according to the present disclosure.

Thereby, in the present disclosure, when the signal display unit is manufactured, it is only required to paste the SMD LED onto the signal display circuit board, and then connect to the exterior circuit board or the signal processing unit via the connection terminal. In the process of manufacturing the signal display unit, it may be not required to fix the LED by the way of applying glue, nor to bend the pins of LED, or even to cut pins. Thereby the process for manufacturing the signal display unit and the process for producing the electrical connector are simplified, and the work efficiency is improved. The present electrical connector may be suitable for automatic mass-production, and the quality of the products as produced may be stable.

### BRIEF DESCRIPTION OF THE DRAWINGS

The above and other features and advantages of the present disclosure will become more apparent from the detailed description of exemplary embodiments thereof with reference to accompany drawings.

FIG. 1A is a schematic view of a conventional LED;

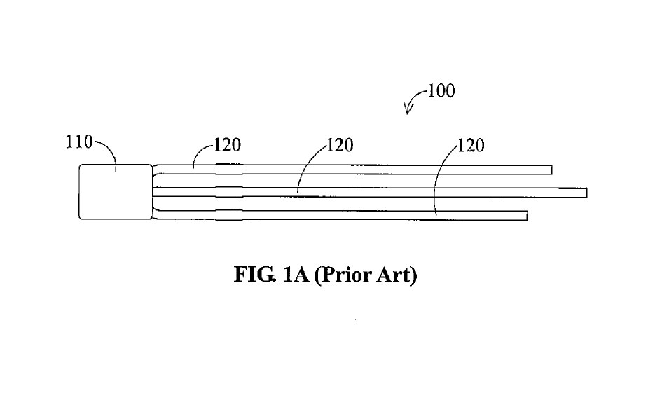

FIG. 1B is a schematic view showing that the conventional LED with bending pins used in an electrical connector;

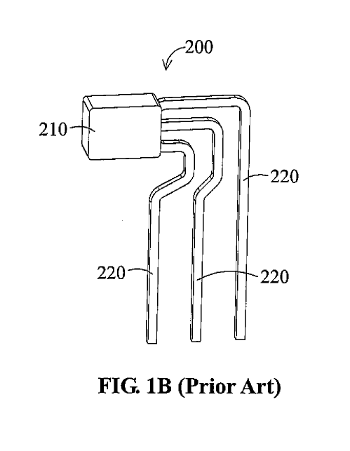

FIG. 2 is a schematic exploded view of an electrical connector according to a first embodiment of the present disclosure;

FIG. 3 is a schematic view of the electrical connector according to the first embodiment of the present disclosure;

FIG. 4 is a schematic view of the electrical connector exploded along the A-A line in FIG. 3, wherein the housing is removed in order to show the internal structure clearly;

FIG. 5 is a sectional view of the electrical connector exploded along the A-A line in FIG. 3, wherein the housing is removed;

FIG. 6 is a sectional view of the electrical connector along the B-B line in FIG. 3;

FIG. 7 is a schematic view based on FIG. 6, in which the housing and the insulation sheets are removed;

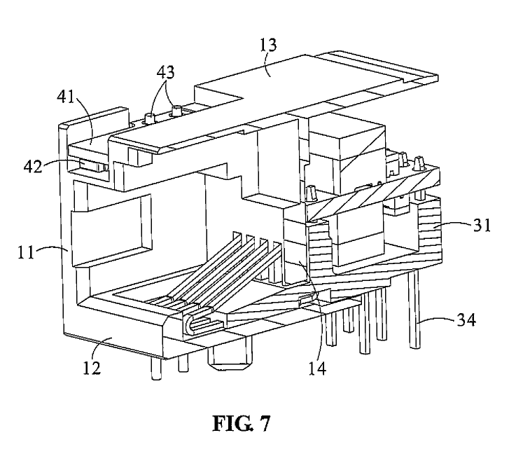

FIG. 8 is a sectional view of an electrical connector according to the first embodiment of the present disclosure, wherein the housing is removed;

FIG. 9 is a sectional view of an electrical connector according to the second embodiment of the present disclosure, wherein the housing is removed;

FIG. 10 is a partially sectional schematic view of an electrical connector according to a third embodiment of the present disclosure, wherein the housing is removed.

FIG. 11 is a schematic view of the signal processing unit in the electrical connector according the third embodiment of the present disclosure.

### DETAILED DESCRIPTION

Now, the exemplary embodiments will be described more fully with reference to the accompany drawings. However, the exemplary embodiments can be implemented in various forms and should not be construed as limited to the embodiments set forth herein. Instead, these embodiments are provided so that this disclosure will be thorough and complete, and the concept of the exemplary embodiment will fully conveyed to those skilled in the art. Same reference signs denote the same or similar structures in the accompany drawings, and thus the detailed description thereof will be omitted.

A First Embodiment of an Electrical Connector

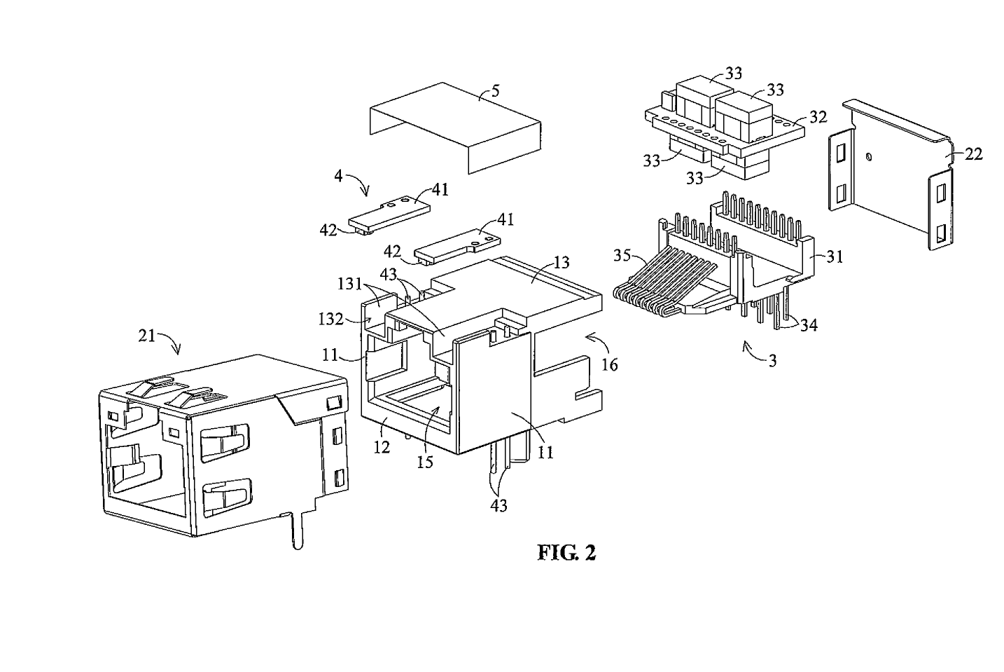

With reference to FIG. 2 to FIG. 6, the electrical connector according to the first embodiment may include an insulator 1, a housing 2, a signal processing unit 3, and two signal display units 4.

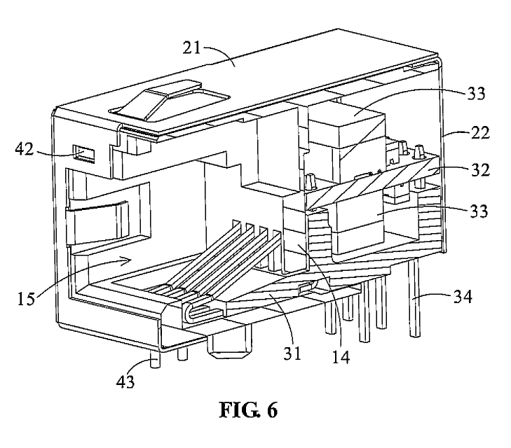

With reference to FIG. 2 and FIG. 6, the insulator body 1 includes two side walls 11 opposite each other, a bottom wall 12 and a top wall 13 opposite each other, and a rear wall 14. And the two side walls 11, the bottom wall 12, the top wall 13 together with the rear wall 14 may define a docking socket 15 having an opening forward. The two side walls 11 and the top wall 13 may extend backwardly to form a module socket 16 having an opening backward with the rear wall 14. There may be a gap between the bottom end portion of the rear wall 14 and the bottom wall 12. The rear wall 14 may be provided with a plurality of through holes. Two accommodating grooves 131 may be provided symmetrically on the top wall 13 over the docking socket 15.

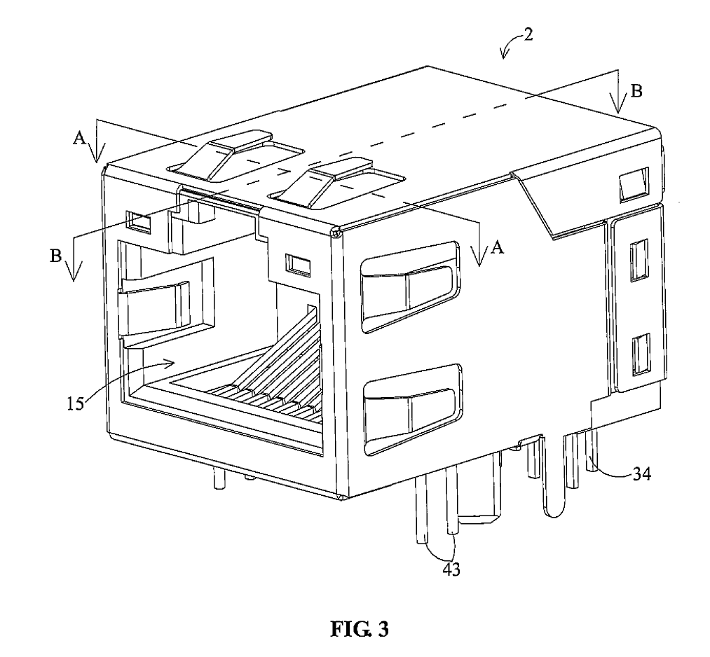

With reference to FIG. 2 and FIG. 3, the housing 2 is provided outside the insulator 1, and the housing 2 may be manufactured with various structures, thus the disclosure is not limited thereto. In the first embodiment, the housing 2 may include a housing body 21 and a rear end shell 22 connected with each other by a snap-fit.

With reference to FIG. 2, the signal processing unit 3 is provided in the insulator 1. The signal processing unit 3 may include a base 31, a signal processing circuit board 32 and four SMD transformers 33 disposed opposite to one another in pairs and connected onto the signal processing circuit board 32. The number of the SMD transformer 33 is not limited to four, and may be increased and decreased properly according to the actual requirements. A base 31 may be provided with a plurality of transfer terminals 34 disposed vertically. The base 31 may be provided with an output terminal 35 protruding forwardly. After accomplishment of assembling, the output terminal 35 may extend into the docking socket 16 through a through hole on the lower end portion of the rear wall 14.

In the first embodiment, there are two signal display units 4. In other embodiments, the number of the signal display unit 4 is not limited to two, and for example, may be as same as the number of the docking sockets 15, or may be twice, four times of the number of the docking sockets 15. The present disclosure is not limited thereto.

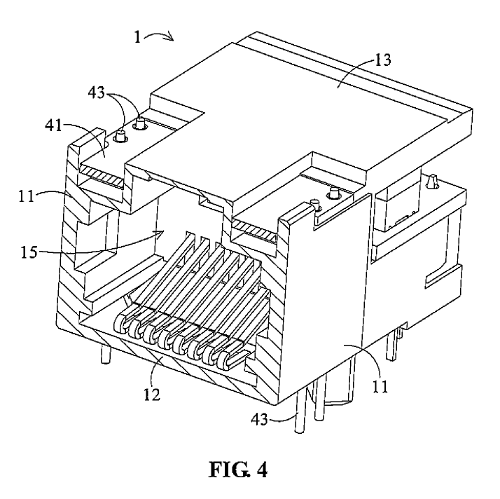

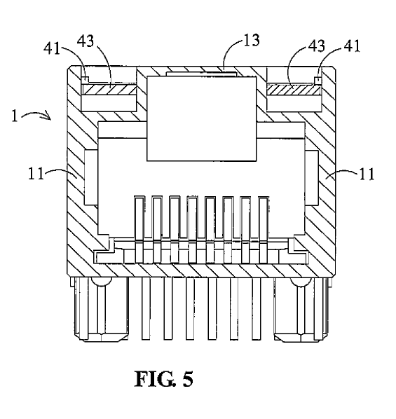

With reference to FIG. 2, FIG. 4 and FIG. 5, the signal display unit 4 may include a signal display circuit board 41, an SMD LED 42 and two connection terminals 43.

The signal display circuit board 41 of the signal display unit 4 may be provided in the accommodating groove 131 of the top wall 13. In other embodiments, the signal display circuit board 41 may be provided on other places of the insulator 1, for example, on the bottom wall 12, the side wall 11 or the rear wall 14 of the insulator 1, and correspondingly, the accommodating groove configured to receive the signal display circuit board 41 may be opened on the bottom wall 12, the side wall 11 or the rear wall 14 of the insulator 1, or a holding structure configured to fix the signal display circuit board 41 may be provided on the bottom wall 12, the side wall 11 or the rear wall 14 of the insulator 1. The present disclosure is not limited thereto.

The SMD LED 42 may be pasted and electrically coupled to the front end portion of the signal display circuit board 41. A display window 132 that transmits light emitted from the SMD LED 42 may be opened on the place of the insulator 1 corresponding to the SMD LED 42. A similar and corresponding display window may also be opened on the housing. But the disclosure is not limited thereto.

In the first embodiment, the signal display unit 4 may only include one SMD LED 42, but the disclosure is not limited thereto, the signal display unit 4 may include a plurality of SMD LEDs 42.

In the first embodiment, the SMD LED 42 may be pasted and electrically coupled to the lower portion of the front end portion of the signal display circuit board 41 (as shown in FIG. 2). In this way, the SMD LED 42 is shielded by the signal display circuit board 41 to prevent light leakage from the upper portion thereof effectively. However, the position of the SMD LED 42 on the signal display circuit board 41 is not limited to the lower portion of the front end portion of the signal display circuit board 41. For example, in other embodiments, the SMD LEDs 42 may be provided on the upper portion of the front end portion or on the front end surface of the signal display circuit board 41. The SMD LED 42 may also be provided on other positions of the signal display circuit board 41, for example, the rear portion, and the middle portion, but not limited to the front end portion of the signal display circuit board 41.

The two connection terminals 43 may be vertically fixed to the side wall 11 of the insulator 1, and have two ends protruding from the side wall 11. The connection terminal 43 may be electrically coupled to the signal display circuit board 41 at its one end portion and electrically coupled to the exterior circuit board (not shown) at its another end portion, but the disclosure is not limited thereto. The number of the connection terminals may not limited to two, and may be determined according to the type of the SMD LED 42, and the number of the connection terminal 43 may be varied. In other embodiments, the lower end portion of the connection terminal 43 may not be electrically coupled to the exterior circuit board but electrically coupled to the signal processing unit 3. The present disclosure is not limited thereto.

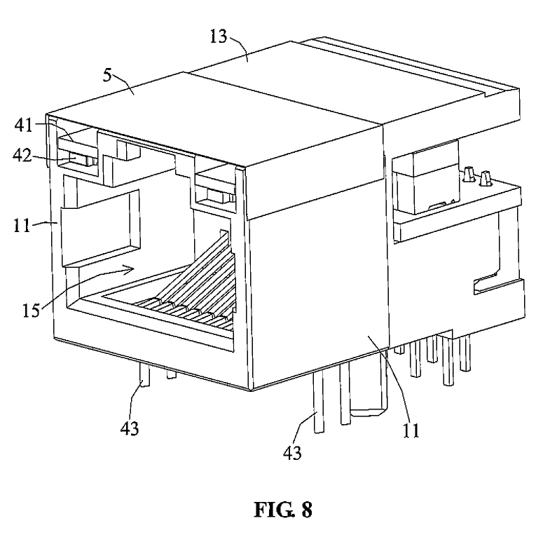

With reference to FIG. 8, in the embodiment, the electrical connector may further include an insulation sheet 5 provided between the insulator 1 and the housing body 21 and covering the accommodating groove 131. The insulation sheet 5 may enhance insulating performance between the connection terminal 43 and the housing, and may be helpful to shield the light.

A Second Embodiment of an Electrical Connector

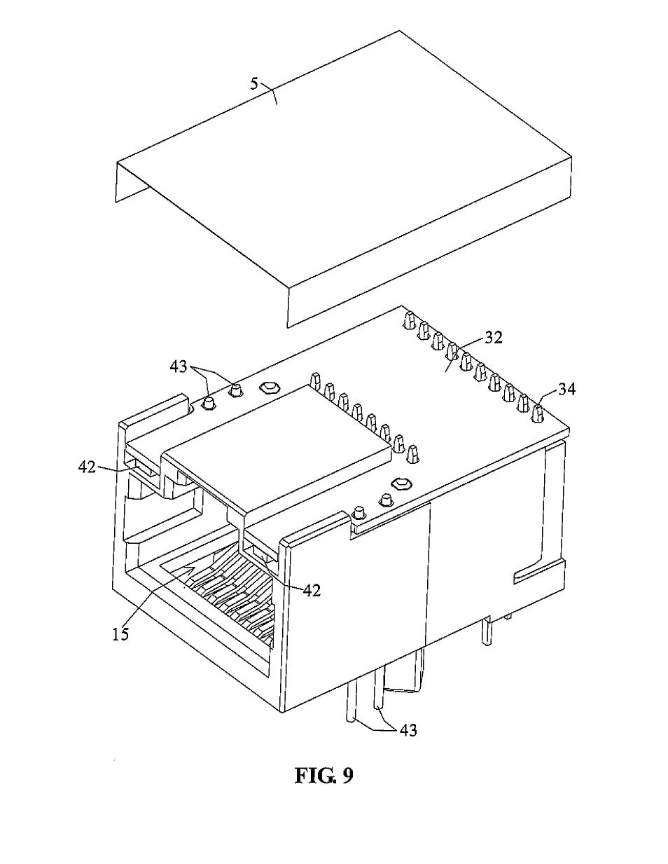

With reference to FIG. 9, the differences between the second embodiment and the first embodiment of the electrical connector according to the present disclosure are presented as follows:

The signal display unit 4 includes at least one SMD LED 42 and at least one connection terminal 43, and the SMD LED 42 is directly pasted and electrically coupled to the signal processing circuit board 32. The connection terminal 43 may be electrically coupled to the signal processing circuit board 32 at its one end and electrically coupled to an exterior circuit board (not shown) at the other end, but the disclosure is not limited thereto. In the second embodiment, the signal display circuit board 41 of the signal display unit 4 according to the first embodiment may correspondingly not be included.

The insulation sheet 5 may cover the whole top wall 13 of the insulator 1 so that not only the insulating performance between the connection terminal 43 and the housing may be enhanced but also the insulating performance between the transfer terminal 34 and the housing may be improved.

The other structures in the second embodiment may be the same as that in the first embodiment of the electrical connector, and will be omitted herein.

A Third Embodiment of an Electric Connector

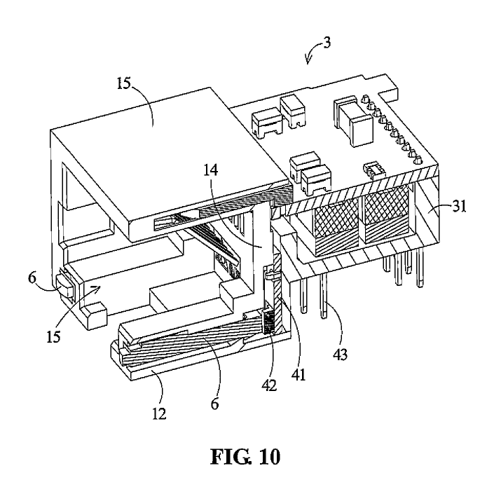

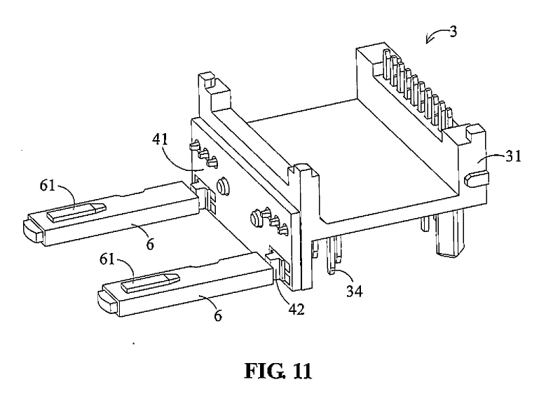

With reference to FIG. 10 and FIG. 11, the differences between the third embodiment and the first embodiment of the electrical connector are presented as follows:

Two accommodating grooves which are penetrated from the front to the back thereof may be provided on the bottom wall 12 of the insulator 1. In the third embodiment, the signal display unit 3 also includes two light guide pillars 6, which are respectively provided in the two accommodating grooves. The light guide pillar 6 may be provided with a holding structure, for example, a protrusion block 61, and the insulator 1 may be correspondingly provided with a holding groove. The holding structure may be matched with the holding groove to firmly fix the light guide pillar 6. The accommodating groove and the light guide pillar are not limited to a long column shape, but may be designed to have a bent curved surface; the present disclosure is not limited thereto.

The signal display circuit board 41 of the signal display unit 4 may be pasted and fixed to the front end portion of the base 31 of the signal processing unit 3. The connection terminal 43 of the signal display unit 4 may be in a shape of “L”, and fixed onto the base 31. In one embodiment, the connection terminal 43 has one end electrically coupled to the signal display circuit board 41 and the other end protruded from the bottom portion of the base 31 and electrically coupled to an exterior circuit board or the signal processing unit 3. The two SMD LEDs 42 of the signal display unit 4 are corresponding to the two light guide pillars 6, respectively, so that the light guide pillars 6 may guide the light emitted from the SMD LEDs 42 to the front end portion of the insulator 1 in order to facilitate for observation from outside.

The number of the light guide pillar 6 is not limited to two, for example, the number of the light guide pillar 6 may be as same as that of the SMD LEDs 42. The present disclosure is not limited thereto.

The other structures in the third embodiment may be the same as that in the first embodiment of the electrical connector, and will be omitted herein.

A Method for Manufacturing the Electrical Connector

A method for manufacturing the electrical connector according to the present disclosure includes the following steps:

providing an insulator 1 having at least one docking socket 15;

providing a signal processing unit 3;

providing at least one signal display unit 4, which includes a signal display circuit board 41 and at least one SMD LED 42 electrically coupled to the signal display circuit board 41;

installing the at least one signal display unit 4 and the signal processing unit 3 on the insulator 1; and

providing a housing 2, and installing the housing 2 outside the insulator 1.

An Embodiment of a Communication Device

A communication device according to an embodiment of the present disclosure includes an electrical connector according to the present disclosure, for example, according to the first embodiment, or the second embodiment, or the third embodiment of the present disclosure, or an electrical connector manufactured by the method according to the present disclosure. The communication device may be for example, a computer, or a mobile phone, or a network switch or a router, etc. The disclosure is not limited thereto.

The exemplary embodiments of the present disclosure have been illustrated and described above. It should be understood that, the present disclosure is not limited to the disclosed embodiments. On the contrary, the present disclosure intends to cover various modifications and equivalent arrangements within the spirit and the scope of the appended claims.

What is claimed is:

1. An electrical connector, comprising:
an insulator, on which at least one docking socket is provided;
a housing provided outside the insulator;
a signal processing unit provided in the insulator; and
at least one signal display unit, which comprises:
a signal display circuit board;
at least one SMD LED electrically coupled to the signal display circuit board; and
at least one connection terminal electrically coupled to an exterior circuit board or the signal processing unit.

2. The electrical connector according to claim 1, wherein the signal processing unit comprises a signal processing circuit board and at least one SMD transformer provided on the signal processing circuit board.

3. The electrical connector according to claim 1, wherein the at least one SMD LED is provided on one end portion of the signal display circuit board.

4. The electrical connector according to claim 3, wherein a display window is provided on the insulator corresponding to the SMD LED.

5. The electrical connector according to claim 1, wherein the insulator comprises at least one accommodating groove, wherein the at least one signal display unit is positioned in the at least one accommodating groove.

6. The electrical connector according to claim 1, wherein the signal display unit further comprises at least one light guide pillar, which is provided on the insulator to guide light emitted from the SMD LED to outside.

7. The electrical connector according to claim 6, wherein the signal display circuit board is provided on a rear end portion of the signal display unit.

8. An electrical connector, comprising:
an insulator, on which at least one docking socket is provided;
a housing provided outside the insulator;
a signal processing unit provided in the insulator and comprising a signal processing circuit board; and
at least one signal display unit, comprising:
at least one SMD LED electrically coupled to the signal processing circuit board.

9. The electrical connector according to claim 8, wherein the signal processing unit comprises at least one SMD transformer.

10. The electrical connector according to claim 8, wherein the SMD LED is positioned on one end portion of the signal processing circuit board.

11. A method for manufacturing the electrical connector, comprising:
providing an insulator, on which at least one docking socket is provided;
providing a signal processing unit;
providing at least one signal display unit, which comprises a signal display circuit board and at least one SMD LED electrically coupled to the signal display circuit board;
installing the at least one signal display unit and the signal processing unit on the insulator; and
installing a housing outside the insulator.

12. A communication device, wherein the communication device comprises the electrical connector according to claim 1.

13. A communication device, wherein the communication device comprises the electrical connector according to claim 8.

14. A communication device, wherein the communication device comprises the electrical connector manufactured according to claim 11.
